(19) United States
(12) Patent Application Publication
(10) Pub. No.: US 2012/0132797 A1
(43) Pub. Date: May 31, 2012

(54) MEANS AND METHODS FOR DIAGNOSING THYROID DISORDERS

(75) Inventors: Volker Strauss, Bad Dürkheim (DE); Hennicke Kamp, Bischheim (DE); Eric Fabian, Ludwigshafen (DE); Georgia Coelho Palermo Cunha, Sao Paulo (BR); Werner Mellert, Hassloch (DE); Bennard van Ravenzwaay, Altrip (DE); Tilmann B. Walk, Kleinmachnow (DE); Ralf Looser, Berlin (DE); Michael Manfred Herold, Berlin (DE); Jan C. Weimer, Berlin (DE); Alexandre Prokoudine, Berlin (DE); Edgar Leibold, Carlsberg (DE)

(73) Assignee: BASF SE, Ludwigshafen (DE)

(21) Appl. No.: 13/389,274

(22) PCT Filed: Jul. 13, 2010
(86) PCT No.: PCT/EP2010/060086

§ 371 Date: Feb. 17, 2012

(30) Foreign Application Priority Data
Aug. 13, 2009 (EP) 09167769.0

(51) Int. Cl. H01J 49/26

(52) U.S. Cl. 250/282

(57) ABSTRACT

The present invention relates to a method for diagnosing thyroid disorders. It also relates to a method of determining whether a compound is capable of inducing a thyroid disorder in a subject and to a method of identifying a drug for treating a thyroid disorder. Furthermore, the present invention relates a device for diagnosing a thyroid disorder and diagnostic uses.

The present invention relates to a method for diagnosing thyroid disorders. It also relates to a method of determining whether a compound is capable of inducing a thyroid disorder in a subject and to a method of identifying a drug for treating a thyroid disorder. Furthermore, the present invention relates a device for diagnosing a thyroid disorder and diagnostic uses.

The thyroid gland is one of the largest of the endocrine tissues Histologically, the thyroid gland consists mainly of follicular cells with a small percentage (about 1%), of calcitonin-producing C-cells, or parafollicular cells. Calcitonin is a 32-amino acid peptide and is synthesized by and released from the C-cells to maintain along with parathyroid hormone calcium homeostasis. In terms of disease, functional disturbances of C-cells are relatively uncommon, although C-cell hyperplasia has been reported in cases of autoimmune thyroiditis, chronic hypercalcemia and familial medullary carcinoma. In terms of thyroid toxicity, however, C-cell toxicity is unimportant. Most toxicological events are associated with the follicular cells that are responsible for synthesis, storage and secretion of the thyroid hormones thyroxine (3,5,3′,5′-tetraiodothyronine, T4) and 3,5,3′-triiodothyronine (T3).

Biosynthesis and secretion of thyroid hormones are under feedback control of the hypothalamic (thyrotropin-releasing hormone, or TRH)—pituitary (thyroid-stimulating hormone, or TSH)—thyroid axis. The inhibitory effects of thyroid hormones and the stimulatory action of TRH (via the hypothalamic-hypophyseal portal system) regulate TSH production in order to maintain optimal thyroid hormone levels. TSH is a glycoprotein composed of two covalently-linked subunits termed α and β. The structure of the α-subunit of TSH resembles that of the other glycoprotein molecules—follicle stimulating hormone (FSH), luteinizing hormone (LH) and human chorionic gonadotropin (hCG). The β-subunit differs in these glycoproteins and is responsible for their biological and immunological specificity.

Inorganic iodide, if which the majority is absorbed in the small intestine from the diet, is oxidized to molecular iodine (I2) and coupled to the tyrosine residue of thyroglobulin by a peroxidase—H2O2 enzyme system to form either monoiodotyrosyl (MIT) or diiodotyrosyl (DIT) residues. Oxidative coupling of two DIT residues forms T4 while coupling of MIT and DIT residues forms T3. Once formed, T4 and T3 are either stored in colloid within the follicular lumen or secreted into the circulation. Once in the cell, the colloid droplets fuse with proteolytic enzymes present within lysosomal bodies. The proteolytic enzymes essentially digest the thyroglobulin, releasing both T3 and T4 into the perifollicular capillaries and lymphatics.

During circulation, thyroid hormones are bound to certain plasma proteins, including thyroxine binding globulin (TBG), transthyretin (TTR—thyroxine binding pre-albumin) or albumin. The presence of these carrier proteins allows larger quantities of these fatsoluble hormones to be carried in the blood, and delays excretion and metabolism of the hormone. TBG and TTR are specific to thyroid hormones and T4 has a greater affinity for these proteins than T3. More than 99% of the circulating hormone is bound to plasma proteins, mainly to thyroxine-binding globulin in man, and to transthyretin and albumin in rodents. T4, which can be viewed basically as a prohormone, is metabolically activated mainly in the liver and kidney, via progressive deiodination enzyme reactions, to form either 3,5,3′-triiodothyronine (“active T3”) or 3,3′,5′-triiodothyronine (basically “inactive T3”=reverse T3, rT3). Three deiodinase families are recognized and are termed isoforms types I, II and III. These three families differ in terms of their tissue localizations, substrate specificities and disease effects. Type I deiodinase, a seleniumdependent enzyme, is the most abundant deiodinase (conversion of T4 to T3) and it is found mainly in the liver, kidneys and thyroid. The type II enzyme is found in the brain, pituitary and brown adipose tissue. This specific deiodinase type is particularly important to TSH pituitary secretion in response to the feedback mechanism because the conversion of T4 to T3 occurs directly at the pituitary cells. The type III deiodinase isoform is also found in the central nervous system and it is responsible for rT3 (inactive T3) generation.

In man, less than 20% of all of the T3 is produced in the thyroid. About 80% of the T4 is metabolized by deiodination, 35% to T3 and 45% to rT3. The remainder is inactivated mostly by glucuronidation in the liver and secretion into bile, or to a lesser extent by sulfonation and deiodination in the liver or kidney. This ability of cells to metabolize T4 to either “active” or “inactive” T3 provides a mechanism for the local control of thyroid hormones. T4 and T3 in the plasma are metabolized by the peripheral tissues and subsequently excreted by the bile. The flow of the formation, metabolism and excretion of thyroid hormones is shown in different modes of action. In toxicology research, for each of the different modes of action, a generally accepted model chemical was selected and an in-depth literature survey was carried out for multiple dose animal studies. These studies were then evaluated for treatment-related changes in thyroid-dependent parameters, especially thyroid weight, thyroid hormone levels (T3, T4 and TSH) and histopathology. (for review see Coelho-Palermo Cunha, G.; van Ravenzwaay, B. (2005) Evaluation of mechanisms inducing thyroid toxicity and the ability of the enhanced OECD Test Guideline 407 to detect these changes. Ach Toxicol, 79, 390-405).

From the above it is evident that thyroid hormone action can be influenced and impaired at different levels and by different stimuli. Besides genetic influences, exogenous stimuli such as xenobiotic chemicals may impair thyroid hormone homeostasis. For example, the thyroid hormone synthesis or secretion may become impaired. Other impairments include thyroid toxicity or thyroid pigmentation. Alternatively, thyroid homeostasis can be impaired by compounds which affect the TSH synthesis and release in the pituitary gland and, thus, the feedback control of thyroid gland. Moreover, the transport of thyroid hormone by thyroid hormone binding proteins may become impaired, e.g., by competition, or the thyroid hormone degradation may become altered. All these effects will result in an impaired thyroid hormone homeostasis and, consequently, in a thyroid disorder including follicular cell hyperplasia and hypertrophy, neoplasia and thyroid tumors.

Sensitive and specific methods for determining efficiently and reliably thyroid disorders and, in particular, the early onset thereof are not available but would, nevertheless, be highly appreciated.

Thus, the invention pertains to a method for diagnosing a thyroid disorder comprising:
(a) determining the amount of at least one analyte selected from any one of Tables 1 to 4 in a test sample of a subject suspected to suffer from a thyroid disorder, and
(b) comparing the amount determined in step (a) to a reference, whereby the thyroid disorder is to be diagnosed.

The expression “method for diagnosing” as referred to in accordance with the present invention means that the method either essentially consists of the aforementioned steps or may include further steps. However, it is to be understood that the method, in a preferred embodiment, is a method carried out ex vivo, i.e. not practised on the human or animal body. Diagnosing as used herein refers to assessing the probability according to which a subject is suffering from a disorder. As will be understood by those skilled in the art, such an assessment, although preferred to be, may usually not be correct for 100% of the subjects to be diagnosed. The term, however, requires that a statistically significant portion of subjects can be identified as suffering from the disease or as having a predisposition therefore, Whether a portion is statistically significant can be determined without further ado by the person skilled in the art using various well known statistic evaluation tools, e.g., determination of confidence intervals, p-value determination, Student's t-test, Mann-Whitney test, etc. Details are found in Dowdy and Wearden, Statistics for Research, John Wiley & Sons, New York 1983. Preferred confidence intervals are at least 50%, at least 60%, at least 70%, at least 80%, at least 90%, at least 95%. The p-values are, preferably, 0.2, 0.1, 0.05.

Diagnosing according to the present invention includes monitoring, confirmation, and classification of the relevant disorder or its symptoms. Monitoring relates to keeping track of an already diagnosed disorder, e.g. to analyze the progression of the disorder, the influence of a particular treatment on the progression of disorder or complications arising during the disorder or after successful treatment of the disorder. Confirmation relates to the strengthening or substantiating a diagnosis already performed using other indicators or markers. Classification relates to allocating the diagnosis according to the strength or kind of symptoms into different classes.

The term “thyroid disorder” refers to pathophysiological conditions in a subject characterized by an impaired thyroid gland function. Said pathophysiological conditions in toxicology are characterized by a decrease in thyroid hormones in the blood and an increase of thyroid stimulating hormone (TSH). Moreover, they are characterized by an increase in thyroid volume and/or weight as well as by follicular cell hyperplasia and hypertrophy. A decrease or increase of thyroid hormones or TSH can be determined by the skilled artisan without further ado. Normal values for these hormones depend on the species of the subject and may depend on physiological influences as well. However, an upper or lower limit of normal which can be used as a threshold for determining whether a subject has an increased or decreased level of the respective hormones can be obtained by statistical measures based on a representative population of subjects which are apparently healthy, in particular, with respect to thyroid disorders. Preferred values for upper and lower limits of normal for different species are as follows:

| | | | | | | TSH | |
|---|---|---|---|---|---|---|---|
| | | | | | | rat: | |
| | | | | T3 | T4 | [μg/L] | |
| Species/ | | | | [nmol/ | [nmol/ | man: | refer- |
| Strain | Age | Sex | N | L] | L] | [mU/L] | ence |
| Humans | adult | both | | 1.4-2.8 | 77-142 | 0.4-4.0 | 1 |
| Rat/Crl: | 17-19 | female | 40 | 1.1-1.7 | 29-47 | 5.2-7.5 | 2 |
| WI(Han) | weeks | male | 40 | 0.7-2.0 | 43-60 | 7.8-10.3 | 2 |
| Rat/Crl: | 21-24 | female | 30 | 0.1-1.7 | 10-45 | 0.3-3.8 | 3 |
| CD(SD) | weeks | male | 30 | 1.0-1.5 | 35-66 | 0.5-4.5 | 3 |

References:
1. Thomas, L. (ed.;1998): Clinical Laboratory Diagnostics, 5^{th} edition, TH-Books, Frankfurt/Main, Germany
2. Experimental Toxicology and Ecology, BASF SE (2009). Normal ranges of thyroid hormones, unpublished
3. York, R. G., Brown, W. R., Girard, M. F., Dollarhide, J. S. (2001). Two-Generation Reproduction Study of Ammonium Perchlorate in Drinking Water in Rats Evaluates Thyroid Toxicity. International Journal of Toxicology, 20, 183-197

Thyroid disorders as used herein, preferably, encompass follicular cell hyperplasia and hypertrophy, neoplasia and thyroid tumors. However, a thyroid disorder as meant herein can also be caused or accompanied by an impaired (e.g., increased) degradation of thyroid hormones by the liver.

The term “analyte” as used herein refers to a chemical molecule which is a metabolite generated in the subject or which is a chemical molecule derived from a metabolite as a result of the sampling procedure, the sample preparation procedure or the actual application of the determination technique used in the methods of the invention. However, it is to be understood that an analyte being derived from the naturally occurring metabolite qualitatively and quantitatively represent the metabolite when determined by the methods referred to herein. The analytes which have been found to be indicative for a thyroid disorder when present in an altered amount with respect to a reference are listed in any one of Tables 1 to 4, below. Moreover, in the said tables, the preferred direction of regulation (i.e. “up” for an increase with respect to a reference and “down” for a decrease with respect to a reference) are indicated as well as preferred relative values for the extent of the increase or decrease (i.e. a value of, e.g., 1.5 means 1.5 times the normal (reference) value).

In principle, metabolites are small molecule compounds, such as substrates for enzymes of metabolic pathways, intermediates of such pathways or the products obtained by a metabolic pathway. Metabolic pathways are well known in the art and may vary between species. Preferably, said pathways include at least citric acid cycle, respiratory chain, thyroid hormone synthesis, glycolysis, gluconeogenesis, hexose monophosphate pathway, oxidative pentose phosphate pathway, production and β-oxidation of fatty acids, urea cycle, amino acid biosynthesis pathways, protein degradation pathways such as proteasomal degradation, amino acid degrading pathways, biosynthesis or degradation of: lipids, polyketides (including e.g. flavonoids and isoflavonoids), isoprenoids (including eg. terpenes, sterols, steroids, carotenoids, xanthophylls), carbohydrates, phenylpropanoids and derivatives, alcaloids, benzenoids, indoles, indole-sulfur compounds, porphyrines, anthocyans, hormones, vitamins, cofactors such as prosthetic groups or electron carriers, lignin, glucosinolates, purines, pyrimidines, nucleosides, nucleotides and related molecules such as tRNAs, microRNAs (miRNA) or mRNAs. Accordingly, small molecule compound metabolites are preferably composed of the following classes of compounds: alcohols, alkanes, alkenes, alkines, aromatic compounds, ketones, aldehydes, carboxylic acids, esters, amines, imines, amides, cyanides, amino acids, peptides, thiols, thioesters, phosphate esters, sulfate esters, thioethers, sulfoxides, ethers, or combinations or derivatives of the aforementioned compounds. The small molecules among the metabolites may be primary metabolites which are required for normal cellular function, organ function or animal growth, development or health. Moreover, small molecule metabolites further comprise secondary metabolites having essential ecological function, e.g. metabolites which allow an organism to adapt to its environment. Furthermore, metabolites are not limited to said primary and secondary metabolites and further encompass artificial small molecule compounds. Said artificial small molecule compounds are derived from exogenously provided small molecules which are administered or taken up by an organism but are not primary or secondary metabolites as defined above. For instance, artificial small molecule compounds may be metabolic products obtained from drugs by metabolic pathways of the animal. Moreover, metabolites further include peptides, oligopeptides, polypeptides, oligonucleotides and polynucleotides, such as RNA or DNA. More preferably, a metabolite has a molecular weight of 50 Da (Dalton) to 30,000 Da, most preferably less than 30,000 Da, less than 20,000 Da, less than 15,000 Da, less than 10,000 Da, less than 8,000 Da, less than 7,000 Da, less than 6,000 Da, less than 5,000 Da, less than 4,000 Da, less than 3,000 Da, less than 2,000 Da, less than 1,000 Da, less than 500 Da, less than 300 Da, less than 200 Da, less than 100 Da. Preferably, a metabolite has, however, a molecular weight of at least 50 Da. Most preferably, a metabolite in accordance with the present invention has a molecular weight of 50 Da up to 1,500 Da.

The phrase “at least one analyte” refers to one or more analytes of the same molecular species. Thus, in this specification, in general, although the singular is used, the term at least one analyte is meant to also referred to a plurality of molecules of the at least one analytes species. However, the term also refers to groups of chemically different analytes which can be determined in accordance with the present invention, i.e. a first analyte of a first molecular species, a second analyte of a second molecular species etc. Preferably, a group of at least three, at least four, at least five or at least six different analytes of the analytes listed in any one of Tales 1 to 4 are to be determined as the at least one analyte. It will be understood that due to statistical reasons even more reliable results will be obtained by the methods of the present invention referred to herein when more than one analyte is determined.

The term “test sample” as used herein refers to samples to be used for the diagnosis of thyroid disorders by the method of the present invention. Said test sample is a biological sample. Preferred biological samples to be used in the method of the present invention are samples from body fluids, preferably, blood, plasma, or serum, or samples derived from thyroid tissues. More preferably, the sample is a blood, plasma or serum sample, most preferably, a plasma sample. Biological samples are derived from a subject as specified elsewhere herein. Techniques for obtaining the aforementioned different types of biological samples are well known in the art. For example, blood samples may be obtained by blood taking while tissue or organ samples are to be obtained, e.g., by biopsy.

The aforementioned samples are, preferably, pre-treated before they are used for the method of the present invention. As described in more detail below, said pre-treatment may include treatments required to release or separate the compounds or to remove excessive material or waste. Suitable techniques comprise centrifugation, extraction, fractioning, ultrafiltration, protein precipitation followed by filtration and purification and/or enrichment of compounds. Moreover, other pre-treatments are carried out in order to provide the compounds in a form or concentration suitable for compound analysis. For example, if gas-chromatography coupled mass spectrometry is used in the method of the present invention, it will be required to derivatize the compounds prior to the said gas chromatography. Suitable and necessary pre-treatments depend on the means used for carrying out the method of the invention and are well known to the person skilled in the art. Pre-treated samples as described before are also comprised by the term “sample” as used in accordance with the present invention.

The term “subject” as used herein relates to animals, preferably to mammals such as mice, rats, guinea pigs, rabbits, hamsters, pigs, sheep, dogs, cats, horses, monkeys, or cows and, also preferably, to humans. More preferably, the subject is a rodent and, most preferably, a rat. Other animals which may be diagnosed applying the method of the present invention are fishes, birds or reptiles. Preferably, said subject was in or has been brought into contact with a compound suspected to be capable of inducing a thyroid disorder. A subject which has been brought into contact with a compound suspected to induce a thyroid disorder may, e.g., be a laboratory animal such as a rat which is used in a screening assay for, e.g., thyroid toxicity of compounds.

The term “determining the amount” as used herein refers to determining at least one characteristic feature of an aforementioned at least one analyte comprised by the sample referred to herein. Characteristic features in accordance with the present invention are features which characterize the physical and/or chemical properties including biochemical properties of an analyte. Such properties include, e.g., molecular weight, viscosity, density, electrical charge, spin, optical activity, colour, fluorescence, chemoluminescence, elementary composition, chemical structure, capability to react with other compounds, capability to elicit a response in a biological read out system (e.g., induction of a reporter gene) and the like. Values for said properties may serve as characteristic features and can be determined by techniques well known in the art. Moreover, the characteristic feature may be any feature which is derived from the values of the physical and/or chemical properties of a metabolite by standard operations, e.g., mathematical calculations such as multiplication, division or logarithmic calculus. Most preferably, the at least one characteristic feature allows the determination and/or chemical identification of the said at least one metabolite and its amount. Accordingly, the characteristic value, preferably, also comprises information relating to the abundance of the metabolite from which the characteristic value is derived. For example, a characteristic value of a metabolite may be a peak in a mass spectrum. Such a peak contains characteristic information of the metabolite, i.e. the mass-to-charge ratio (m/z) information, as well as an intensity value being related to the abundance of the said metabolite (i.e. its amount) in the sample.

As discussed before, the aforementioned at least one analyte comprised by a test sample may be, preferably, determined in accordance with the present invention quantitatively or semi-quantitatively. For quantitative determination, either the absolute or precise amount of the analyte will be determined or the relative amount of the analyte will be determined based on the value determined for the characteristic feature(s) referred to herein above. The relative amount may be determined in a case were the precise amount of an analyte can or shall not be determined. In said case, it can be determined whether the amount in which the analyte is present is enlarged or diminished with respect to a second sample comprising said analyte in a second amount. Quantitatively analysing a metabolite, thus, also includes what is sometimes referred to as semi-quantitative analysis of a metabolite.

Moreover, determining as used in the method of the present invention, preferably, includes using a compound separation step prior to the analysis step referred to before. Preferably, said compound separation step yields a time resolved separation of the metabolites comprised by the sample. Suitable techniques for separation to be used preferably in accordance with the present invention, therefore, include all chromatographic separation techniques such as liquid chromatography (LC), high performance liquid chromatography (HPLC), gas chromatography (GC), thin layer chromatography, size exclusion or affinity chromatography. These techniques are well known in the art and can be applied by the person skilled in the art without further ado. Most preferably, LC and/or GC are chromatographic techniques to be envisaged by the method of the present invention. Suitable devices for such determination of metabolites are well known in the art. Preferably, mass spectrometry is used in particular gas chromatography mass spectrometry (GC-MS), liquid chromatography mass spectrometry (LC-MS), direct infusion mass spectrometry or Fourier transform ion-cyclotrone-resonance mass spectrometry (FT-ICR-MS), capillary electrophoresis mass spectrometry (CE-MS), high-performance liquid chromatography coupled mass spectrometry (HPLC-MS), quadrupole mass spectrometry, any sequentially coupled mass spectrometry, such as MS-MS or MS-MS-MS, inductively coupled plasma mass spectrometry (ICP-MS), pyrolysis mass spectrometry (Py-MS), ion mobility mass spectrometry or time of flight mass spectrometry (TOF). Most preferably, LC-MS and/or GC-MS are used as described in detail below. Said techniques are disclosed in, e.g., Nissen, Journal of Chromatography A, 703, 1995: 37-57, U.S. Pat. No. 4,540,884 or U.S. Pat. No. 5,397,894, the disclosure content of which is hereby incorporated by reference. As an alternative or in addition to mass spectrometry techniques, the following techniques may be used for compound determination: nuclear magnetic resonance (NMR), magnetic resonance imaging (MRI), Fourier transform infrared analysis (FT-IR), ultraviolet (UV) spectroscopy, refraction index (RI), fluorescent detection, radiochemical detection, electrochemical detection, light scattering (LS), dispersive Raman spectroscopy or flame ionisation detection (FID). These techniques are well known to the person skilled in the art and can be applied without further ado. The method of the present invention shall be, preferably, assisted by automation. For example, sample processing or pre-treatment can be automated by robotics. Data processing and comparison is, preferably, assisted by suitable computer programs and databases. Automation as described herein before allows using the method of the present invention in high-throughput approaches.

Moreover, the said at least one analyte can also be determined by a specific chemical or biological assay. Said assay shall comprise means which allow to specifically detect the at least one analyte in the sample. Preferably, said means are capable of specifically recognizing the chemical structure of the analyte or are capable of specifically identifying the analyte based on its capability to react with other compounds or its capability to elicit a response in a biological read out system (e.g., induction of a reporter gene). Means which are capable of specifically recognizing the chemical structure of a analyte are, preferably, antibodies or other proteins which specifically interact with chemical structures, such as receptors or enzymes. Specific antibodies, for instance, may be obtained using the analyte as antigen by methods well known in the art. Anti-bodies as referred to herein include both polyclonal and monoclonal antibodies, as well as fragments thereof, such as Fv, Fab and F(ab)₂ fragments that are capable of binding the antigen or hapten. The present invention also includes humanized hybrid antibodies wherein amino acid sequences of a non-human donor antibody exhibiting a desired antigen-specificity are combined with sequences of a human acceptor antibody. Moreover, encompassed are single chain antibodies. The donor sequences will usually include at least the antigen-binding amino acid residues of the donor but may comprise other structurally and/or functionally relevant amino acid residues of the donor antibody as well. Such hybrids can be prepared by several methods well known in the art. Suitable proteins which are capable of specifically recognizing the analyte are, preferably, enzymes which are involved in the metabolic conversion of the analyte and its corresponding metabolite, respectively. Said enzymes may either use the analyte as a substrate or may convert a substrate into the analyte. Moreover, said antibodies may be used as a basis to generate oligopeptides which specifically recognize the analyte. These oligopeptides shall, for example, comprise the enzyme's binding domains or pockets for the said analyte. Suitable antibody and/or enzyme based assays may be RIA (radioimmunoassay), ELISA (enzyme-linked immunosorbent assay), sandwich enzyme immune tests, electrochemiluminescence sandwich immunoassays (ECLIA), dissociation-enhanced lanthanide fluoro immuno assay (DELFIA) or solid phase immune tests. Moreover, the analyte may also be identified based on its capability to react with other compounds, i.e. by a specific chemical reaction. Further, the analyte may be determined in a sample due to its capability to elicit a response in a biological read out system. The biological response shall be detected as read out indicating the presence and/or the amount of the analyte comprised by the sample. The biological response may be, e.g., the induction of gene expression or a phenotypic response of a cell or an organism.

The term “reference” refers to values of characteristic features of the analyte which can be correlated to a thyroid disorder. Such reference results are, preferably, obtained from a sample derived from a subject suffering from a thyroid disorder. Preferably, such a subject has been brought into contact with a compound being capable of inducing a thyroid disorder. A subject may be brought into contact with a compound being capable of inducing a thyroid disorder by either topic or systemic administration mode as long as the compound is bioavailable. The reference results may be determined as described hereinabove for the amounts of the analytes. It will be understood that the reference may also be obtained as the average or median or a related parameter from a plurality of such samples. Compounds known to induce a thyroid disorder are well known in the art and comprise Ethylenethiourea, Metaflumizone, Methimazole, 6-Propyl-2-thiouracil, 2-Methylimidazole, Dimethylpyrazolphosphate, Aroclor, Boscalid, Fipronil, Pendimethalin, Metazachlor or Phenobarbital sodium.

Alternatively, but nevertheless also preferred, the reference results may be obtained from sample derived from a subject which has not been brought into contact with a compound known to induce a thyroid disorder i.e. an apparently healthy subject with respect to thyroid disorders and, more preferably, other diseases as well. Again, it will be understood that the reference may also be obtained as the average or median or a related parameter from a plurality of such samples.

Moreover, the reference, also preferably, could be a calculated reference, most preferably, the average or median, for the relative or absolute amount for the analyte derived from a population or cohort of individuals comprising the subject to be investigated. However, it is to be understood that the population of subjects to be investigated for determining a calculated reference, preferably, either consist of apparently healthy subjects (e.g. untreated) or comprise a number of apparently healthy subjects which is large enough to be statistically resistant against significant average or median changes due to the presence of the test subject(s) in the said population. The absolute or relative amounts of the metabolites of said individuals of the population can be determined as specified elsewhere herein. How to calculate a suitable reference value, preferably, the average or median, is well known in the art. The population of subjects referred to before shall comprise a plurality of subjects, preferably, at least 5, 10, 50, 100, 1,000 or 10,000 subjects. It is to be understood that the subject to be diagnosed by the method of the present invention and the subjects of the said plurality of subjects are of the same species and are, preferably, also gender and/or age matched.

More preferably, the reference results, i.e. values for at least one characteristic features of an analyte, will be stored in a suitable data storage medium such as a database and are, thus, also available for future diagnoses. This also allows efficiently diagnosing a predisposition for a thyroid disorder because suitable reference results can be identified in the database once it has been confirmed (in the future) that the subject from which the corresponding reference sample was obtained (indeed) developed the thyroid disorder.

The term “comparing” refers to assessing whether the results of the determination described hereinabove in detail, i.e. the results of the qualitative or quantitative determination of an analyte, are essentially identical to reference results or differ therefrom.

In case the reference results are obtained from one or more samples derived from subjects which have been brought into contact with a compound being an inducer of a thyroid disorder, the said disorder can be diagnosed based on the degree of identity between the test results obtained from the test sample and the aforementioned reference results, i.e. based on an identical or similar qualitative or quantitative composition with respect to the aforementioned analyte(s). The results of the test sample and the reference results are identical, if the values for the characteristic features and, in the case of quantitative determination, the intensity values are identical. Said results are similar, if the values of the characteristic features are identical but the intensity values are different. Such a difference is, preferably, not significant and shall be characterized in that the values for the intensity are within at least the interval between 1^{s}′ and 99^{th} percentile, 5^{th} and 95^{th} percentile, 10^{th} and 90^{th} percentile, 20^{th} and 80^{th} percentile, 30^{th} and 70^{th} percentile, 40^{th} and 60^{th} percentile of the reference value the 50^{th}, 60^{th}, 70^{1h} 80^{th}, 90^{th} or 95^{th} percentile of the reference value.

In case the reference results are obtained form one or more samples of derived from subjects which have not been brought into contact with a compound being an inducer of a thyroid disorder or from apparently healthy subjects, the thyroid disorder can be diagnosed based on the differences between the test results obtained from the test sample and the aforementioned reference results, i.e. differences in the qualitative or quantitative composition with respect to the aforementioned analyte(s). The same applies if a calculated reference as specified above is used. The difference may be an increase in the absolute or relative amount of a metabolite (sometimes referred to as up-regulation of the metabolite; see also Examples) or a decrease in either of said amounts or the absence of a detectable amount of the metabolite (sometimes referred to as down-regulation of the metabolite; see also Examples). Preferably, the difference in the relative or absolute amount is significant, i.e. outside of the interval between 45^{th} and 55^{th} percentile, 40^{th} and 60^{th} percentile, 30^{th} and 70^{th} percentile, 20^{th} and 80^{th} percentile, 10^{th} and 90^{th} percentile, 5^{th} and 95^{th} percentile, 1^{st} and 99^{th} percentile of the reference value.

For the specific metabolites referred to in this specification, preferred values for the changes in the relative amounts (i.e. “fold”—changes) or the direction of change (i.e. “up”- or “down”-regulation resulting in a higher or lower relative and/or absolute amount) are indicated in the following Tables 1 to 4, below.

The comparison is, preferably, assisted by automation. For example, a suitable computer program comprising algorithm for the comparison of two different data sets (e.g., data sets comprising the values of the characteristic feature(s)) may be used, Such computer programs and algorithm are well known in the art. Notwithstanding the above, a comparison can also be carried out manually.

The aforementioned methods for the determination of analytes can be implemented into a device. A device as used herein shall comprise at least the aforementioned means, i.e. an analyzing unit for determining the amount of the at least one analyte and an evaluation unit allowing for a comparison of the determined amount with a reference. The units of the device are, preferably, operatively linked to each other. How to link the units in an operating manner will depend on the type of means included into the device. For example, where units for automatically qualitatively or quantitatively determining an analyte are applied, the data obtained by said automatically operating units can be processed by, e.g., a computer program in order to facilitate the diagnosis.

Preferably, the units are comprised by a single device in such a case. Said device may accordingly include an analyzing unit and a computer unit for processing the resulting data for the diagnosis. Alternatively, where units such as test stripes are used for determining the analytes, the units for diagnosing may comprise control stripes or tables allocating the determined result data to result data known to be accompanied with a thyroid disorder or those being indicative for a healthy subject as discussed above.

Alternatively, the methods for the determination of the anaylte(s) can be implemented into a system comprising several devices which are, preferably, operatively linked to each other. Specifically, the devices must be linked in a manner as to allow carrying out the method of the present invention as described in detail above. Therefore, operatively linked, as used herein, preferably, means functionally linked. Depending on the devices to be used for the system of the present invention, said devices may be functionally linked by connecting each device with the other by means which allow data transport in between said devices, e.g., glass fiber cables, and other cables for high throughput data transport. Nevertheless, wireless data transfer between the devices is also envisaged by the present invention, e.g., via a LAN (including Wireless LAN, WLAN, Internet). A preferred system comprises devices for determining analytes. Such devices encompass units for separating analytes, such as chromatographic devices, and units for analyte determination, such as mass spectrometry devices. Suitable devices have been described in detail above. Preferred units for compound separation to be used in the system of the present invention include chromatographic devices, more preferably, devices for liquid chromatography, HPLC, and/or gas chromatography. Preferred devices for compound determination comprise mass spectrometry devices, more preferably, GC-MS, LC-MS, direct infusion mass spectrometry, FT-ICR-MS, CE-MS, HPLC-MS, quadrupole mass spectrometry, sequentially coupled mass spectrometry (including MS-MS or MS-MS-MS), ICP-MS, Py-MS or TOF. The separation and determination units are, preferably, coupled to each other. Most preferably, LC-MS and/or GC-MS is used in the system of the present invention as described in detail elsewhere in the specification. Further comprised shall be units for comparing and/or evaluating the results obtained from the units for determination of analytes. Said units may comprise at least one databases and an implemented computer program for comparison of the results. Preferred embodiments of the aforementioned systems and devices are also described in detail below.

In a preferred embodiment of the method of the present invention the at least one analyte is selected from the group of analytes listed in Table 1. More preferably, the subject is a female. Even more preferably, the thyroid disorder is accompanied by an impaired thyroid hormone synthesis in the thyroid gland.

In another preferred embodiment of the method of the present invention the at least one analyte is selected from the group of analytes listed in Table 2. More preferably, the subject is a male. Even more preferably, the thyroid disorder is accompanied by an impaired thyroid hormone synthesis in the thyroid gland.

In a preferred embodiment of the method of the present invention the at least one analyte is selected from the group of analytes listed in Table 3. More preferably, the subject is a female. Even more preferably, the thyroid disorder is accompanied by an impaired thyroid hormone degradation in the liver. Such an impaired thyroid hormone degradation may result in a hypothyroid condition caused by impaired microsomal liver enzyme induction or activity.

In yet another preferred embodiment of the method of the present invention the at least one analyte is selected from the group of analytes listed in Table 4. More preferably, the subject is a male. Even more preferably, the thyroid disorder is accompanied by an impaired thyroid hormone degradation in the liver, e.g., as discussed above.

Advantageously, it has been found in the study underlying the present invention that the amount of an analyte or a group of analytes as listed in any one of Tables 1 to 4 serves as a biomarker for diagnosing a thyroid disorder. Thanks to the present invention, thyroid disorders can be more efficiently and reliably diagnosed—even more, the causes may be determined more accurately, i.e. either an impaired thyroid hormone synthesis or an altered degradation of the thyroid hormones caused by the liver. Moreover, based on the aforementioned findings, screening for compounds which are suspected to be capable of inducing thyroid disorders has become possible, e.g., in the context of toxicological assessments. Further, the findings are the basis for screening assays for drugs which are useful for the therapy of thyroid disorders.

Therefore, the present invention also relates to a method of determining whether a compound is capable of inducing a thyroid disorder in a subject comprising:
(a) determining in a sample of a subject which has been brought into contact with a compound suspected to be capable of inducing a thyroid disorder the amount of at least one analyte of any one of Tables 1 to 4; and
(b) comparing the amount determined in step (a) to a reference, whereby the capability of the compound to induce a thyroid disorder is determined.

Moreover, the present invention also encompasses a method of identifying a substance for treating a thyroid disorder comprising the steps of:
(a) determining in a sample of a subject suffering from a thyroid disorder which has been brought into contact with a candidate substance for treating said disorder the amount of at least one analyte of any one of Tables 1 to 4; and
(b) comparing the amount determined in step (a) to a reference, whereby the said substance is to be identified.

All definitions and explanations of the terms made above apply mutatis mutandis for the aforementioned methods and all other embodiments described further below except stated otherwise in the following. Specifically, in case of the method of identifying a substance useful for treating a thyroid disorder, said reference is, preferably, derived from a subject, which has been brought into contact with a compound being an inducer of a thyroid disorder or a group of such subjects. More preferably, amounts for the analytes which differ in the test sample and the reference are indicative for a substance useful for treating the said thyroid disorder. Alternatively, the said reference may be, preferably, derived from a subject which has not been brought into contact with a compound being an inducer of a thyroid disorder or a group of such subjects (preferably, from apparently healthy subjects) or may be a calculated reference for the analytes in a population or cohort of subjects. If such a reference is used, essentially identical amounts for the analytes in the test sample and the reference are indicative for a substance useful for treating the thyroid disorder.

The term “substance for treating a thyroid disorder” refers to compounds which may directly interfere with impaired thyroid hormone synthesis and/or altered degradation of thyroid hormones in the liver. Substances to be screened by the method of the present invention may be organic and inorganic chemicals, such as small molecules, polynucleotides, oligonucleotides, peptides, polypeptides including antibodies or other artificial or biological polymers. Preferably, the substances are suitable as drugs, pro-drugs or lead substances for the development of drugs or pro-drugs.

It is to be understood that if the methods of the present invention are to be used for identifying drugs for the therapy of a thyroid disorder or for toxicological assessments of compounds (i.e. determining whether a compound is capable of inducing a thyroid disorder), test samples of a plurality of subjects may be investigated for statistical reasons. Preferably, the metabolome within such a cohort of test subjects shall be as similar as possible in order to avoid differences which are caused, e.g., by factors other than the compound to be investigated. Subjects to be used for the said methods are, preferably, laboratory animals such as rodents and, more preferably, rats. It is to be understood further that the said laboratory animals shall be, preferably, sacrificed after completion of the method of the present invention. All subjects of a cohort test and reference animals shall be kept under identical conditions to avoid any differential environmental influences. Preferred conditions for rats which have an essentially identical metabolome are disclosed in WO 2007/014825, the disclosure content of which is hereby incorporated by reference.

Also, the present invention pertains to a data collection comprising characteristic values for the analytes listed in Table 1, 2, 3 and/or 4.

The term “data collection” refers to a collection of data which may be physically and/or logically grouped together. Accordingly, the data collection may be implemented in a single data storage medium or in physically separated data storage media being operatively linked to each other. Preferably, the data collection is implemented by means of a database. Thus, a database as used herein comprises the data collection on a suitable storage medium. Moreover, the database, preferably, further comprises a database management system. The database management system is, preferably, a networkbased, hierarchical or object-oriented database management system. Furthermore, the database may be a federal or integrated database. More preferably, the database will be implemented as a distributed (federal) system, e.g. as a Client-Server-System. More preferably, the database is structured as to allow a search algorithm to compare a test data set with the data sets comprised by the data collection. Specifically, by using such an algorithm, the database can be searched for similar or identical data sets being indicative for a thyroid disorder (e.g. a query search). Thus, if an identical or similar data set can be identified in the data collection, the test data set will be associated with a thyroid disorder. Consequently, the information obtained from the data collection can be used to diagnose a thyroid disorder based on a test data set obtained from a subject.

Also envisaged by the present invention is a data storage medium comprising the aforementioned data collection of the present invention.

The term “data storage medium” as used herein encompasses data storage media which are based on single physical entities such as a CD, a CD-ROM, a hard disk, optical storage media, or a diskette. Moreover, the term further includes data storage media consisting of physically separated entities which are operatively linked to each other in a manner as to provide the aforementioned data collection, preferably, in a suitable way for a query search.

The present invention further relates to a system comprising
(a) a unit for comparing characteristic values of analytes of a sample operatively linked to
(b) a data storage medium as defined above.

The term “system” as used herein relates to different entities or units which are operatively linked to each other. Said entities or units may be implemented in a single device or may be implemented in physically separated devices which are operatively linked to each other. The unit for comparing characteristic values of metabolites operate, preferably, based on an algorithm for comparison as mentioned before. The data storage medium, preferably, comprises the aforementioned data collection or database, wherein each of the stored data sets being indicative for a thyroid disorder. Thus, the system of the present invention allows identifying whether a test data set is comprised by the data collection stored in the data storage medium. Consequently, the system of the present invention may be applied as a diagnostic device in diagnosing a thyroid disorder.

In a preferred embodiment of the system, an analyzing unit for determining characteristic values of analytes of a sample is comprised.

The term “analyzing unit for determining characteristic values of analytes” preferably relates to the aforementioned devices for the determination of analytes, such as mass spectrometry devices, NMR devices or devices for carrying out chemical or biological assays for the analytes. Detection as used herein may be a two-step process, i.e. the compound may first bind specifically to the analyte to be detected and subsequently generate a detectable signal, e.g., fluorescent signals, chemiluminescent signals, radioactive signals and the like. For the generation of the detectable signal, further compounds may be required which are all comprised by the term. Compounds which specifically bind to the analyte are described elsewhere in the specification in detail and include, preferably, enzymes, antibodies, ligands, receptors or other biological molecules or chemicals which specifically bind to the analytes.

The present invention encompasses also a diagnostic composition comprising the at least one analyte from any one of Tables 1 to 4 or means for the determination thereof.

Furthermore, encompassed by the present invention is a device for diagnosing a thyroid disorder comprising
(a) an analyzing unit for determining characteristic values of at least one analyte selected from any one of Tables 1 to 4; and
(b) an evaluation unit allowing for a thyroid disorder based on a comparison of the characteristic values determined by the analyzing unit and reference values indicative for a thyroid disorder.

In general, the present invention pertains to the use of at least one analyte as listed in any one of Tables 1 to 4 or means for the determination thereof for the manufacture of a diagnostic device or composition for diagnosing a thyroid disorder in a subject or to the use of such an analyte in a sample of a subject for diagnosing a thyroid disorder.

In a preferred embodiment of the aforementioned uses, the analytes of Table 1 are for female subjects and, more preferably, the thyroid disorder is caused by impaired thyroid hormone synthesis.

In a preferred embodiment of the aforementioned uses, the analytes of Table 2 are for male subjects and, more preferably, the thyroid disorder is caused by impaired thyroid hormone synthesis.

In a preferred embodiment of the aforementioned uses, the analytes of Table 3 are for female subjects and, more preferably, the thyroid disorder is caused by impaired thyroid hormone degradation in the liver.

In a preferred embodiment of the aforementioned uses, the analytes of Table 4 are for male subjects and, more preferably, the thyroid disorder is caused by impaired thyroid hormone degradation in the liver.

All references referred to above are herewith incorporated by reference with respect to their entire disclosure content as well as their specific disclosure content explicitly referred to in the above description.

The following Examples are merely for the purposes of illustrating the present invention. They shall not be construed, whatsoever, to limit the scope of the invention in any respect.

### EXAMPLES

### Example

### Biomarkers for Compound-Induced Thyroid Disorders

Wistar (Crl:WI(Han)) rats (supplied by Charles River Laboratories, Germany) were housed under acclimatized conditions as described in Strauss et al., 2009. At the beginning of the study the animals were 10-11 weeks old. Each dose group in the studies consisted of five rats per sex, and was compared with controls (10 rats per sex). Preferably, the test substances were administered via feed or gavage, but intra-peritonial, sub-cutaneous and intra-muscular injections were also used according to the formulation of the compounds. The dose levels were chosen to show the typical overt (high dose) and slight (low dose) toxicological symptoms of the substances as described in the literature or in BASF internal study reports.

Blood samples were withdrawn from the retro-orbital sinus in all rats under isoflurane anesthesia on study days 7, 14 and 28 after a fasting period of 16-20 hours. Plasma samples were prepared (Strauβ et al., 2009) and used for analysis.

For mass spectrometry-based metabolite profiling analysis, plasma samples were extracted by a proprietary method which delivers a polar and a non-polar fraction. For GC-MS analysis, the non-polar fraction was treated with methanol under acidic conditions to yield the fatty acid methyl esters. Both fractions were further derivatised with Omethyl-hydroxyamine hydrochloride and pyridine to convert oxo groups to Omethyloximes and subsequently with a silylating agent before analysis.

In LC-MS/MS analysis, both fractions were reconstituted in appropriate solvent mixtures. HPLC was performed by gradient elution on reversed phase separation columns. For mass spectrometric detection metanomics proprietary technology was applied, which allows target and high sensitivity MRM (Multiple Reaction Monitoring) profiling in parallel to a full screen analysis. The method resulted in 269 unique analytes for semi-quantitative analysis, 187 of which were chemically identified and 82 were unknown. Moreover, several hundred additional analytes giving a fingerprint of the sample were included in the methods.

Following comprehensive analytical validation steps, the data for each analyte were normalized against data from pool samples. These samples were run in parallel through the whole process to account for process variability.

The sex- and day-stratified heteroscedastic t-test (“Welch test”) was applied to compare treated groups with respective controls. p-Values and ratios of corresponding group medians were collected as metabolic profiles and fed into a database.

The changes of the group of plasma analytes (metabolites) being indicative for thyroid disorders after treatment of rats with the indicated known inducers of thyroid function impairment are shown in the following Tables 1 to 4:

TABLE 1
Analytes serving as thyroid disorder biomarkers in female rats (effect on thyroid hormone synthesis)

| | | Ethylene- | | | Meta- | | | | | | 6-Propyl- | | | Ethylene- | | |
|---|---|---|---|---|---|---|---|---|---|---|---|---|---|---|---|---|
| | | thiourea | | | flumizone | | | Methimazole | | | 2-thiouracil | | | thiourea | | |
| Metabolite | Direction | fh7 | fh14 | fh28 | fh7 | fh14 | fh28 | fh7 | fh14 | fh28 | fh7 | fh14 | fh28 | fh7 | fh14 | fh28 |
| Docosahexaenoic | up | 1.29 | 1.24 | 1.11 | 1.52 | 2.54 | 1.98 | 2.16 | 1.32 | 1.22 | 1.25 | 1.14 | 0.84 | 1.12 | 1.45 | 1.22 |
| acid (C22:cis | | | | | | | | | | | | | | | | |
| [4,7,10,13,16]6) | | | | | | | | | | | | | | | | |
| Tricosanoic | up | 1.44 | 1.30 | 1.05 | 1.28 | 1.41 | 2.56 | 2.05 | 2.54 | 1.96 | 1.45 | 1.30 | 1.36 | 1.38 | 1.52 | 1.42 |
| acid (C23:0) | | | | | | | | | | | | | | | | |
| Behenic acid | up | 1.27 | 1.69 | 1.27 | 1.12 | 1.28 | 2.03 | 2.08 | 2.63 | 2.03 | 1.27 | 1.14 | 1.23 | 1.48 | 1.29 | 1.69 |
| (C22:0) | | | | | | | | | | | | | | | | |
| threo-Sphingosine | up | 1.58 | 1.61 | 1.26 | 1.29 | 1.27 | 1.89 | 2.46 | 3.21 | 2.37 | 1.24 | 1.29 | 1.34 | 1.35 | 1.47 | 1.51 |
| 5-O-Methyl- | up | 1.20 | 1.59 | 1.59 | 0.99 | 1.42 | 2.07 | 3.55 | 3.80 | 2.83 | 1.40 | 1.36 | 1.20 | 1.29 | 1.56 | 1.63 |
| sphingosine | | | | | | | | | | | | | | | | |
| erythro- | up | 1.39 | 1.98 | 1.35 | 1.25 | 1.50 | 1.82 | 2.56 | 3.21 | 2.44 | 1.46 | 1.28 | 1.24 | 1.46 | 1.71 | 1.51 |
| Sphingosine | | | | | | | | | | | | | | | | |
| Pyruvate | down | 0.74 | 1.14 | 1.04 | 0.64 | 0.54 | 0.72 | 0.62 | 0.53 | 0.79 | 0.91 | 0.65 | 0.73 | 1.29 | 0.79 | 0.69 |
| Glycine | up | 1.09 | 1.18 | 1.01 | 0.93 | 0.97 | 1.63 | 1.14 | 1.14 | 1.28 | 1.13 | 1.08 | 1.05 | 1.21 | 1.24 | 1.32 |
| Citrate | down | 0.78 | 0.86 | 0.91 | 0.84 | 0.62 | 0.88 | 0.83 | 0.76 | 0.84 | 0.87 | 0.69 | 0.66 | 0.89 | 0.85 | 0.70 |
| Asparagine | up | 1.35 | 1.27 | 0.84 | 0.75 | 0.57 | 1.17 | 1.17 | 1.12 | 1.12 | 1.10 | 1.09 | 0.93 | 1.06 | 1.31 | 1.26 |
| Ketoleucine | down | 0.84 | 0.82 | 0.74 | 0.97 | 0.81 | 0.81 | 0.86 | 0.80 | 0.78 | 1.05 | 0.80 | 0.89 | 0.93 | 0.84 | 0.88 |
| Lysophosphatidyl- | up | 1.08 | 1.17 | 1.23 | 0.88 | 1.20 | 1.11 | 1.52 | 1.57 | 1.31 | 1.07 | 1.31 | 1.26 | 1.08 | 1.19 | 1.10 |
| choline (C18:2) | | | | | | | | | | | | | | | | |
| Sphingomyelin | up | 1.62 | 1.55 | 1.38 | 1.29 | 1.45 | 1.38 | 1.89 | 2.54 | 1.77 | 1.01 | 1.46 | 1.62 | 1.71 | 1.43 | 1.70 |
| (d18:1, C16:0) | | | | | | | | | | | | | | | | |
| Phosphatidylcholine | up | 1.26 | 1.54 | 1.30 | 1.14 | 1.40 | 1.86 | 1.89 | 2.40 | 2.21 | 1.49 | 1.37 | 1.09 | 1.43 | 1.43 | 1.41 |
| (C16:1, C18:2) | | | | | | | | | | | | | | | | |
| Phosphatidylcholine | up | 1.02 | 1.09 | 1.04 | 1.14 | 1.16 | 1.20 | 1.39 | 1.25 | 1.33 | 1.20 | 1.17 | 1.17 | 1.09 | 1.15 | 1.06 |
| (C18:2, C20:4) | | | | | | | | | | | | | | | | |
| Sphingomyelin | up | 1.46 | 1.34 | 1.07 | 0.97 | 1.10 | 1.15 | 1.45 | 1.44 | 1.31 | 1.26 | 1.33 | 1.29 | 1.29 | 1.06 | 1.16 |
| (d18:1, C16:0) | | | | | | | | | | | | | | | | |

TABLE 2
Analytes serving as thyroid disorder biomarkers in male rats (effect on thyroid hormone synthesis)

| | | Methimazole | | | 6-Propyl-2-thiouracil | | | Ethylenethiourea | | |
|---|---|---|---|---|---|---|---|---|---|---|
| Metabolite | Direction | mh7 | mh14 | mh28 | mh7 | mh14 | mh28 | mh7 | mh14 | mh28 |
| Arginine | up | 1.09 | 1.09 | 1.14 | 1.09 | 1.10 | 1.35 | 1.24 | 1.30 | 1.20 |
| Glutamate | down | 0.61 | 0.57 | 0.46 | 0.78 | 0.78 | 0.65 | 1.07 | 0.73 | 0.70 |
| alpha-Tocopherol | up | 1.76 | 2.66 | 2.18 | 1.20 | 1.15 | 1.12 | 2.58 | 2.99 | 3.13 |
| Lignoceric acid (C24:0) | up | 2.12 | 2.82 | 2.16 | 1.28 | 1.12 | 1.16 | 1.94 | 1.66 | 2.07 |
| Tricosanoic acid (C23:0) | up | 1.93 | 2.69 | 2.50 | 1.28 | 1.10 | 1.55 | 1.67 | 2.01 | 2.39 |
| Phytosphingosine | up | 2.08 | 2.92 | 3.04 | 1.11 | 1.07 | 1.20 | 1.53 | 1.67 | 2.17 |
| 14-Methyl-Pentadecanoic acid | down | 1.13 | 0.85 | 0.54 | 0.98 | 0.86 | 0.64 | 0.98 | 0.96 | 0.77 |
| 17-Methyloctadecanoic acid | down | 1.36 | 0.92 | 0.45 | 1.10 | 0.67 | 0.70 | 0.97 | 0.83 | 0.89 |
| Dihom-gamma-Linolenic acid | up | 2.38 | 3.22 | 2.02 | 1.02 | 1.33 | 1.50 | 2.34 | 1.84 | 2.68 |
| (C20:cis[8,11,14]3) | | | | | | | | | | |
| 3-O-Methylsphingosine | up | 3.47 | 3.85 | 4.55 | 1.57 | 1.41 | 1.90 | 2.26 | 2.34 | 2.91 |
| threo-Sphingosine | up | 3.02 | 3.78 | 4.30 | 1.33 | 1.23 | 1.52 | 2.05 | 2.03 | 2.05 |
| 5-O-Methylsphingosine | up | 3.57 | 4.15 | 3.40 | 1.50 | 1.38 | 1.82 | 2.36 | 2.37 | 2.78 |
| erythro-Sphingosine | up | 2.92 | 3.71 | 3.47 | 1.46 | 1.30 | 1.47 | 2.06 | 2.06 | 2.29 |
| Cholesterol | up | 1.98 | 2.31 | 2.03 | 1.42 | 0.98 | 1.23 | 1.74 | 2.25 | 1.98 |
| Citrate | down | 0.69 | 0.69 | 0.73 | 0.90 | 0.73 | 0.64 | 0.86 | 0.81 | 0.64 |
| Glutamate | down | 0.75 | 0.49 | 0.40 | 1.03 | 0.70 | 0.49 | 1.15 | 0.82 | 0.77 |
| Sphingomyelin (d18:1, C16:0) | up | 2.24 | 2.27 | 1.92 | 1.35 | 1.35 | 1.71 | 1.65 | 1.69 | 1.79 |

TABLE 3
Analytes serving as thyroid disorder biomarkers in female rats (effect on thyroid hormone degradation (liver))

| | | | | | 3,4-Dimethyl- | | | | | |
|---|---|---|---|---|---|---|---|---|---|---|
| | | 2-Methylimidazole | | | pyrazolphosphat | | | Aroclor 1254 | | |
| Metabolite | Direction | fh7 | fh14 | fh28 | fh7 | fh14 | fh28 | fh7 | fh14 | fh28 |
| Palmitic acid (C16:0) | up | 1.21 | 1.30 | 1.44 | 1.34 | 1.34 | 1.55 | 1.16 | 1.27 | 1.19 |
| Linoleic acid (C18:cis[9,12]2) | up | 1.19 | 1.27 | 1.21 | 1.29 | 1.29 | 1.44 | 1.34 | 1.34 | 1.54 |
| Stearic acid (C18:0) | up | 0.99 | 1.02 | 1.17 | 1.30 | 1.71 | 1.62 | 1.34 | 1.54 | 1.91 |
| Arachidonic acid | up | 1.04 | 1.20 | 1.36 | 1.36 | 1.75 | 1.67 | 1.25 | 1.48 | 1.53 |
| (C20:cis[58,11,14]4) | | | | | | | | | | |
| Docosahexaenoic acid | up | 1.37 | 1.42 | 1.27 | 2.15 | 2.19 | 2.25 | 1.21 | 1.66 | 1.45 |
| (C22:cis[4,7,10,13,16,19]6) | | | | | | | | | | |
| Cholesterol | up | 1.14 | 1.41 | 1.55 | 1.24 | 1.73 | 1.69 | 1.43 | 1.45 | 1.53 |
| Glycerol phosphate | up | 1.21 | 1.26 | 1.26 | 1.29 | 1.69 | 1.55 | 1.31 | 1.68 | 1.89 |
| Dodecanol | up | 1.06 | 1.11 | 1.05 | 1.06 | 1.17 | 1.26 | 1.31 | 1.27 | 1.26 |
| Heptadecanoic acid (C17:0) | up | 1.14 | 1.27 | 1.38 | 1.30 | 1.34 | 1.39 | 1.39 | 1.10 | 1.40 |
| Eicosanoic acid (C20:0) | up | 1.06 | 1.34 | 1.15 | 1.14 | 1.61 | 1.38 | 1.87 | 2.25 | 1.40 |
| myo-Inositol-2-phosphate | up | 1.61 | 1.60 | 1.70 | 1.26 | 1.78 | 1.91 | 2.01 | 1.91 | 1.23 |
| Behenic acid (C22:0) | up | 1.34 | 1.25 | 1.34 | 1.31 | 1.82 | 1.43 | 1.57 | 1.27 | 1.24 |
| Nervonic acid (C24:cis[15]1) | up | 1.11 | 1.52 | 1.74 | 1.60 | 1.60 | 1.78 | 1.20 | 1.13 | 1.31 |
| gamma-Linolenic acid | up | 0.91 | 1.67 | 2.30 | 1.17 | 1.87 | 1.96 | 1.61 | 1.26 | 1.33 |
| (C18:cis[6,9,12]3) | | | | | | | | | | |
| dihomo-gamma-Linolenic acid | up | 0.83 | 1.53 | 1.26 | 1.36 | 1.80 | 1.86 | 1.54 | 1.68 | 2.44 |
| (C20:cis[8,11,14]3) | | | | | | | | | | |
| threo-Sphingosine | up | 1.28 | 1.63 | 1.66 | 1.27 | 1.72 | 1.58 | 1.32 | 1.53 | 1.74 |
| erythro-Sphingosine | up | 1.38 | 1.61 | 1.69 | 1.40 | 1.90 | 1.54 | 1.16 | 1.91 | 1.37 |
| Cysteine | down | 0.70 | 0.63 | 0.76 | 0.78 | 1.29 | 1.00 | 0.74 | 0.79 | 0.62 |
| Threonic acid | up | 1.45 | 1.26 | 0.98 | 1.51 | 1.17 | 1.36 | 2.11 | 1.87 | 2.00 |
| Sphingomyelin (d18:1, C16:0) | up | 1.34 | 1.26 | 1.27 | 1.28 | 1.35 | 1.58 | 1.47 | 1.37 | 1.56 |
| | | Boscalid | | | Fipronil | | | Pendimethalin | | |
| Metabolite | Direction | fh7 | fh14 | fh28 | fh7 | fh14 | fh28 | fh7 | fh14 | fh28 |
| Palmitic acid (C16:0) | up | 1.23 | 1.19 | 1.08 | 1.05 | 1.40 | 1.16 | 1.49 | 1.81 | 1.67 |
| Linoleic acid (C18:cis[9,12]2) | up | 1.33 | 1.35 | 1.27 | 1.36 | 1.72 | 1.45 | 1.38 | 1.63 | 1.36 |
| Stearic acid (C18:0) | up | 1.71 | 1.61 | 1.56 | 0.87 | 1.40 | 1.55 | 1.86 | 1.97 | 2.12 |
| Arachidonic acid | up | 1.76 | 1.60 | 1.53 | 0.91 | 1.56 | 1.61 | 2.07 | 2.24 | 2.31 |
| (C20:cis[58,11,14]4) | | | | | | | | | | |
| Docosahexaenoic acid | up | 1.62 | 1.41 | 1.36 | 1.38 | 2.12 | 1.71 | 1.85 | 1.82 | 1.85 |
| (C22:cis[4,7,10,13,16,19]6) | | | | | | | | | | |
| Cholesterol | up | 1.74 | 1.47 | 1.47 | 1.10 | 1.73 | 1.65 | 2.09 | 2.17 | 2.44 |
| Glycerol phosphate | up | 1.50 | 1.44 | 1.16 | 0.90 | 1.26 | 1.40 | 1.91 | 1.93 | 2.06 |
| Dodecanol | up | 1.27 | 1.50 | 1.48 | 0.98 | 1.22 | 1.17 | 1.24 | 1.31 | 1.31 |
| Heptadecanoic acid (C17:0) | up | 1.37 | 1.45 | 1.23 | 1.02 | 1.31 | 1.35 | 1.35 | 1.56 | 1.63 |
| Eicosanoic acid (C20:0) | up | 1.75 | 1.33 | 1.64 | 0.81 | 1.65 | 1.27 | 1.52 | 1.82 | 1.61 |
| myo-Inositol-2-phosphate | up | 2.07 | 2.37 | 1.98 | 1.08 | 1.20 | 1.71 | 2.82 | 2.74 | 2.66 |
| Behenic acid (C22:0) | up | 1.85 | 1.44 | 1.78 | 1.24 | 1.72 | 1.78 | 2.05 | 1.89 | 1.94 |
| Nervonic acid (C24:cis[15]1) | up | 2.34 | 1.77 | 2.08 | 1.12 | 1.57 | 1.79 | 3.51 | 2.62 | 2.54 |
| gamma-Linolenic acid | up | 1.30 | 1.74 | 1.49 | 0.88 | 1.67 | 1.68 | 1.61 | 2.29 | 2.57 |
| (C18:cis[6,9,12]3) | | | | | | | | | | |
| dihomo-gamma-Linolenic acid | up | 1.62 | 1.74 | 1.59 | 1.18 | 1.96 | 1.48 | 1.77 | 3.05 | 2.43 |
| (C20:cis[8,11,14]3) | | | | | | | | | | |
| threo-Sphingosine | up | 1.92 | 1.99 | 1.91 | 1.23 | 1.49 | 1.83 | 2.95 | 2.67 | 2.49 |
| erythro-Sphingosine | up | 2.22 | 1.81 | 2.19 | 1.26 | 1.72 | 1.86 | 3.26 | 2.60 | 2.81 |
| Cysteine | down | 0.61 | 0.59 | 0.74 | 0.48 | 0.79 | 0.95 | 0.52 | 0.56 | 0.95 |
| Threonic acid | up | 1.81 | 1.46 | 1.52 | 1.90 | 1.50 | 1.25 | 1.85 | 1.79 | 2.05 |
| Sphingomyelin (d18:1, C16:0) | up | 1.58 | 1.71 | 1.27 | 1.01 | 1.13 | 1.33 | 2.01 | 1.64 | 1.58 |

TABLE 4
Analytes serving as thyroid disorder biomarkers in male rats (effect on thyroid hormone degradation (liver))

| | | | | | | | | Phenobarbital | | | | | |
|---|---|---|---|---|---|---|---|---|---|---|---|---|---|
| | | Boscalid | | | Metazachlor | | | sodium | | | Methimazole | | |
| Metabolite | Direction | mh7 | mh14 | mh28 | mh7 | mh14 | mh28 | mh7 | mh14 | mh28 | mh7 | mh14 | mh28 |
| Stearic acid (C18:0) | up | 1.52 | 1.64 | 1.43 | 1.45 | 2.36 | 2.59 | 0.99 | 1.19 | 1.09 | 1.34 | 1.40 | 1.16 |
| Cholesterol | up | 1.25 | 1.39 | 1.30 | 1.71 | 2.15 | 2.43 | 1.16 | 1.09 | 1.18 | 1.69 | 1.93 | 1.56 |
| Glycerol phosphate | up | 1.40 | 1.39 | 1.48 | 1.63 | 2.20 | 2.36 | 1.05 | 1.04 | 1.05 | 2.09 | 1.67 | 1.46 |
| Galactose, lipid | up | 1.25 | 1.59 | 1.25 | 1.81 | 2.27 | 2.57 | 1.12 | 1.18 | 1.06 | 1.60 | 1.46 | 1.53 |
| fraction | | | | | | | | | | | | | |
| Lignoceric acid | up | 1.44 | 1.62 | 1.31 | 1.60 | 2.38 | 2.11 | 1.21 | 1.18 | 1.25 | 2.12 | 2.82 | 2.16 |
| (C24:0) | | | | | | | | | | | | | |
| myo-Inositol-2- | up | 1.77 | 2.15 | 1.80 | 2.17 | 4.01 | 2.79 | 1.26 | 1.16 | 1.15 | 2.55 | 2.35 | 1.85 |
| phosphate | | | | | | | | | | | | | |
| Behenic acid (C22:0) | up | 1.43 | 1.34 | 1.20 | 1.92 | 2.47 | 2.05 | 1.03 | 1.11 | 1.21 | 2.02 | 3.03 | 3.01 |
| Nervonic acid | up | 2.68 | 3.38 | 2.54 | 3.17 | 4.00 | 3.63 | 1.27 | 1.77 | 1.65 | 2.59 | 3.00 | 2.23 |
| C24:(cis[15]1) | | | | | | | | | | | | | |
| dihomo-gamma- | up | 1.75 | 1.67 | 1.57 | 2.41 | 5.18 | 3.36 | 1.06 | 1.03 | 0.96 | 2.38 | 3.22 | 2.02 |
| Linolenic acis | | | | | | | | | | | | | |
| (C20:cis[8,11,14]3) | | | | | | | | | | | | | |
| threo-Sphingosine | up | 1.71 | 2.15 | 1.90 | 2.05 | 3.22 | 3.54 | 1.39 | 1.61 | 1.50 | 3.02 | 3.78 | 4.30 |
| erythro-Sphingosine | up | 1.73 | 2.35 | 2.05 | 2.31 | 3.47 | 3.68 | 1.39 | 1.56 | 1.65 | 2.92 | 3.71 | 3.47 |
| Glycine | up | 1.23 | 1.40 | 1.58 | 1.12 | 1.10 | 1.26 | 0.95 | 1.18 | 1.12 | 1.42 | 1.25 | 0.98 |
| Citrate | down | 0.89 | 1.05 | 0.99 | 0.99 | 0.94 | 1.08 | 0.89 | 0.93 | 0.96 | 0.69 | 0.69 | 0.73 |
| Mannose | up | 1.15 | 1.20 | 1.06 | 1.22 | 1.37 | 1.46 | 1.08 | 1.05 | 1.09 | 1.06 | 1.04 | 0.87 |
| Threonic acid | up | 1.24 | 1.24 | 1.45 | 1.16 | 1.25 | 1.36 | 1.86 | 1.95 | 1.88 | 0.72 | 0.69 | 0.69 |
| Cytosine | down | 0.83 | 0.92 | 0.78 | 0.64 | 0.75 | 0.66 | 1.06 | 1.07 | 0.98 | 0.65 | 0.46 | 0.39 |
| Sphingomyelin | up | 2.08 | 1.83 | 1.72 | 2.54 | 2.36 | 2.32 | 1.30 | 1.55 | 1.44 | 2.24 | 2.27 | 1.92 |
| (d18:1, C16:0) | | | | | | | | | | | | | |
| Phospha-tidylcholine | up | 1.05 | 1.09 | 1.07 | 1.40 | 1.55 | 1.51 | 1.13 | 1.14 | 1.05 | 1.11 | 1.28 | 1.35 |
| (C18:0, 18:2) | | | | | | | | | | | | | |

| | | |
|---|---|---|
| Aroclor 1254 | Fipronil | Pendimethalin |

| Metabolite | Direction | mh7 | mh14 | mh28 | mh7 | mh14 | mh28 | mh7 | mh14 | mh28 |
|---|---|---|---|---|---|---|---|---|---|---|
| Stearic acid (C18:0) | up | 1.50 | 1.65 | 1.69 | 1.28 | 1.43 | 1.39 | 1.64 | 2.28 | 2.12 |
| Cholesterol | up | 1.38 | 1.41 | 1.33 | 1.29 | 1.54 | 1.17 | 1.67 | 2.03 | 2.29 |
| Glycerol phosphate | up | 1.21 | 1.31 | 1.36 | 1.15 | 1.36 | 1.37 | 2.06 | 2.38 | 2.34 |
| Galactose, lipid | up | 1.44 | 1.41 | 1.61 | 1.22 | 1.36 | 1.21 | 1.81 | 2.03 | 2.23 |
| fraction | | | | | | | | | | |
| Lignoceric acid | up | 1.40 | 1.29 | 1.28 | 1.33 | 1.55 | 1.27 | 2.32 | 2.93 | 2.42 |
| (C24:0) | | | | | | | | | | |
| myo-Inositol-2- | up | 1.17 | 1.85 | 1.80 | 1.22 | 2.04 | 1.99 | 3.25 | 3.57 | 2.79 |
| phosphate | | | | | | | | | | |
| Behenic acid (C22:0) | up | 1.27 | 1.56 | 1.40 | 1.10 | 1.20 | 1.18 | 1.94 | 1.90 | 1.79 |
| Nervonic acid | up | 1.23 | 1.56 | 1.64 | 1.58 | 1.95 | 2.08 | 2.90 | 2.99 | 3.07 |
| C24:(cis[15]1) | | | | | | | | | | |
| dihomo-gamma- | up | 2.14 | 1.44 | 2.11 | 2.05 | 2.60 | 1.77 | 2.92 | 3.53 | 2.76 |
| Linolenic acis | | | | | | | | | | |
| (C20:cis[8,11,14]3) | | | | | | | | | | |
| threo-Sphingosine | up | 1.35 | 1.46 | 1.58 | 1.35 | 1.65 | 1.34 | 2.96 | 3.52 | 2.73 |
| erythro-Sphingosine | up | 1.40 | 1.62 | 1.64 | 1.42 | 1.80 | 1.46 | 2.78 | 3.33 | 2.69 |
| Glycine | up | 1.47 | 1.69 | 1.71 | 1.24 | 1.51 | 1.64 | 1.11 | 1.15 | 1.32 |
| Citrate | down | 1.08 | 1.01 | 0.83 | 0.92 | 0.92 | 1.13 | 0.86 | 0.83 | 0.87 |
| Mannose | up | 1.11 | 1.17 | 1.07 | 1.15 | 1.28 | 1.04 | 1.31 | 1.39 | 1.40 |
| Threonic acid | up | 1.68 | 1.82 | 2.90 | 1.08 | 1.30 | 1.25 | 1.39 | 1.47 | 1.85 |
| Cytosine | down | 1.07 | 1.12 | 0.96 | 0.81 | 0.94 | 0.93 | 0.79 | 0.92 | 0.81 |
| Sphingomyelin | up | 1.44 | 1.70 | 1.63 | 1.28 | 1.35 | 1.38 | 2.10 | 1.97 | 2.03 |
| (d18:1, C16:0) | | | | | | | | | | |
| Phospha-tidylcholine | up | 1.10 | 1.15 | 1.14 | 1.29 | 1.22 | 1.20 | 1.26 | 1.25 | 1.32 |
| (C18:0, 18:2) | | | | | | | | | | |

1-15. (canceled)

16. A method for diagnosing a thyroid disorder comprising:
(a) determining the amount of at least one analyte selected from any one of Tables 1 to 4 in a test sample of a subject suspected to suffer from a thyroid disorder, and
(b) comparing the amount determined in step (a) to a reference, whereby the thyroid disorder is to be diagnosed.

17. The method of claim 16, wherein said subject has been brought into contact with a compound suspected to be capable of inducing a thyroid disorder.

18. The method of claim 16, wherein said reference is derived from a subject which suffers from a thyroid disorder.

19. The method of claim 18, wherein essentially identical amounts for the said at least one analyte in the test sample and the reference are indicative for a thyroid disorder.

20. The method of claim 16, wherein said reference is (i) derived from a subject known to not suffer from a thyroid disorder or is (ii) a calculated reference for the said at least one analyte for a population of subjects.

21. The method of claim 20, wherein amounts which differ in the test sample in comparison to the reference for the at least one analyte are indicative for a thyroid disorder.

22. A method of determining whether a compound is capable of inducing a thyroid disorder in a subject comprising:
(a) determining in a sample of a subject which has been brought into contact with a compound suspected to be capable of inducing a thyroid disorder the amount of at least one analyte selected from any one of Tables 1 to 4; and
(b) comparing the amount determined in step (a) to a reference, whereby the capability of the compound to induce a thyroid disorder is determined.

23. The method of claim 22, wherein said reference is derived from a subject which suffers from a thyroid disorder.

24. The method of claim 23, wherein essentially identical amounts for the said at least one analyte in the test sample and the reference are indicative for a thyroid disorder.

25. The method of claim 22, wherein said reference is (i) derived from a subject known to not suffer from a thyroid disorder or is (ii) a calculated reference for the said at least one analyte for a population of subjects.

26. The method of claim 25, wherein amounts which differ in the test sample in comparison to the reference for the at least one analyte are indicative for a thyroid disorder.

27. A method of identifying a substance for treating a thyroid disorder comprising the steps of:
(a) determining in a sample of a subject suffering from a thyroid disorder which has been brought into contact with a candidate substance for treating the thyroid disorder the amount of at least one analyte selected from any one of Tables 1 to 4; and
(b) comparing the amounts determined in step (a) to a reference, whereby a substance for treating a thyroid disorder is to be identified.

28. The method of claim 27, wherein said reference is derived from a subject which suffers from a thyroid disorder.

29. The method of claim 28, wherein amounts which differ in the test sample and the reference for the said at least one analyte are indicative for a substance for treating a thyroid disorder.

30. The method of claim 27, wherein said reference is (i) derived from a subject known to not suffer from a thyroid disorder or is (ii) a calculated reference for the said at least one analyte for a population of subjects.

31. The method of claim 30, wherein essentially identical amounts for the at least one analyte in the test sample and the reference are indicative for a substance for treating a thyroid disorder.

32. The method of claim 27, wherein said thyroid disorder is selected from the group consisting of: follicular cell hyperplasia and hypertrophy, neoplasia, thyroid tumors.

33. A device for diagnosing a thyroid disorder comprising
(a) an analyzing unit for determining characteristic values of at least one analyte selected from any one of Tables 1 to 4; and
(b) an evaluation unit allowing for a thyroid disorder based on a comparison of the characteristic values determined by the analyzing unit and reference values indicative for a thyroid disorder.
